(19) United States
(12) Patent Application Publication
(10) Pub. No.: US 2004/0196470 A1
(43) Pub. Date: Oct. 7, 2004

(54) Raster image processing (RIP) manager for enhanced print shop operation

(76) Inventor: Robert D. Christiansen, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/404,355

(22) Filed: Apr. 1, 2003

(51) Int. Cl. G06F 15/00

(52) U.S. Cl. 358/1.1; 358/1.15; 715/525

(57) ABSTRACT

In one embodiment, a raster image processing (RIP) manager is configured to distribute partitions of a print job to a RIP pipeline to be RIPed. If the RIP manager anticipates a delay in the RIP pipeline, the RIP manager adds a RIP engine to the RIP pipeline.

### RELATED APPLICATIONS

This patent application is related to U.S. patent application Ser. No. ______, titled “xxxxxxxxxxxxx”, filed on ______, commonly assigned herewith, and hereby incorporated by reference.

### TECHNICAL FIELD

This disclosure relates to a raster image processing manager for enhanced print shop management.

### BACKGROUND

Raster image processing (RIP) is the process of translating digital image data into bit-mapped device-ready data or raster bits for rendering. Such digital image data is generally embodied in one of a number of different page description languages (PDLs) such as Hewlett-Packard Printer Control Language (PCL), Adobe Portable Document Format (PDF), or Adobe PostScript® (PS) but can also be embodied within stand-alone images such as JPEG or TIFF files. In the printing field, a RIP (raster image processor) or set of RIPs are commonly used by print shops to prepare jobs or documents so they can be printed on a printing press. To this end, print shop administers generally must manually allocate and configure RIP resources to RIP PCL, PS, or PDF documents as well as JPEG, TIFF, or EPS images. The RIP resources can be implemented in hardware or software.

One or more RIP resources allocated and configured to work on a particular print job—or a particular class of print jobs (e.g. PDF print jobs)—can be referred to as a pipeline. When a pipeline consists of multiple RIP resources, the resources may be implemented across any number of computing devices. Pipelines are typically configured to RIP a single PDL type at a time; however, a pipeline may be configured to RIP documents of more than a single PDL type at a time. Repeated configuration and/or allocation of RIP resources across various pipelines can be a common activity in print shop environments. This is because the nature and requirements of print shop workflow can change from hour-to-hour, day-to-day, and so on.

For example, a print shop may need to process a large PDF print job in the morning, a number of PS print jobs in the afternoon, and a number of PCL print jobs during the night. In this example, all or some amount of the total available RIP resources need to be assigned to a pipeline in the morning to RIP the large PDF job, some amount of the available RIP resources need to be assigned to a pipeline in the afternoon to RIP the PS jobs, and some amount of the available RIP resources need to be assigned to a pipeline at night to RIP each of the PCL jobs. In any one of these scenarios, the amount of RIP resources required by any pipeline is a function of numerous criteria, including, but not limited to, the number of current RIP projects, the print job sizes, the speed at which the print jobs need to be processed, and anticipated and unanticipated print shop workflow.

Unfortunately, variations in the number of incoming print jobs, the variations in the type of incoming jobs, and the possible failure of one or more RIP engine(s) within one or more pipelines can result in frequent need to reconfigure RIP pipelines. It is also unfortunate that reconfiguring pipelines with RIP resources can be a time consuming and laborious process that can substantially impede print shop throughput. For example, it is common for printing presses to sit idle until such pipeline configuration is complete. In view of this, efficient systems and techniques to configure, re-configure and manage pipelines with appropriate RIP resources, and to manage failures resulting from the RIP processes, are greatly desired to enhance print shop workflow.

### SUMMARY

In one embodiment, a raster image processing (RIP) manager is configured to distribute partitions of a print job to a RIP pipeline to be RIPed. If the RIP manager anticipates a delay in the RIP pipeline, the RIP manager adds a RIP engine to the RIP pipeline.

### BRIEF DESCRIPTION OF THE DRAWINGS

The following detailed description refers to the accompanying figures. In the figures, the left-most digits(s) of a reference number identifies the figure (FIG.) in which the reference number first appears. Moreover, the same reference numbers are used throughout the drawings to reference like features and components.

FIG. 1 is an exemplary embodiment of a suitable computing environment within which exemplary embodiments of systems, apparatuses and methods to enhance management of RIP resources may be implemented.

FIG. 2 shows an exemplary embodiment of a computer system to enhance management of RIP resources.

FIG. 3 shows an exemplary embodiment of additional detail of an exemplary embodiment of a RIP manager.

FIG. 4 shows an exemplary embodiment of a user interface for communication with the exemplary embodiment of the RIP manager.

FIG. 5 shows an exemplary embodiment of a method to enhance management of RIP resources.

FIG. 6 shows an exemplary embodiment of a method to anticipate, detect and/or respond to delays in the RIP pipeline.

FIG. 7 shows an exemplary embodiment of a method to add or replace RIP engines within a pipeline.

### DETAILED DESCRIPTION

Although not required for embodiment, the raster image processing (RIP) manager for enhanced print shop operation will be described in the general context of computer-executable instructions, such as program modules, being executed by a computer. Program modules generally include routines, programs, objects, components, data structures, etc., that perform particular tasks or implement particular abstract data types. Where the computing environment is distributed, program modules may be located in both local and remote memory storage devices.

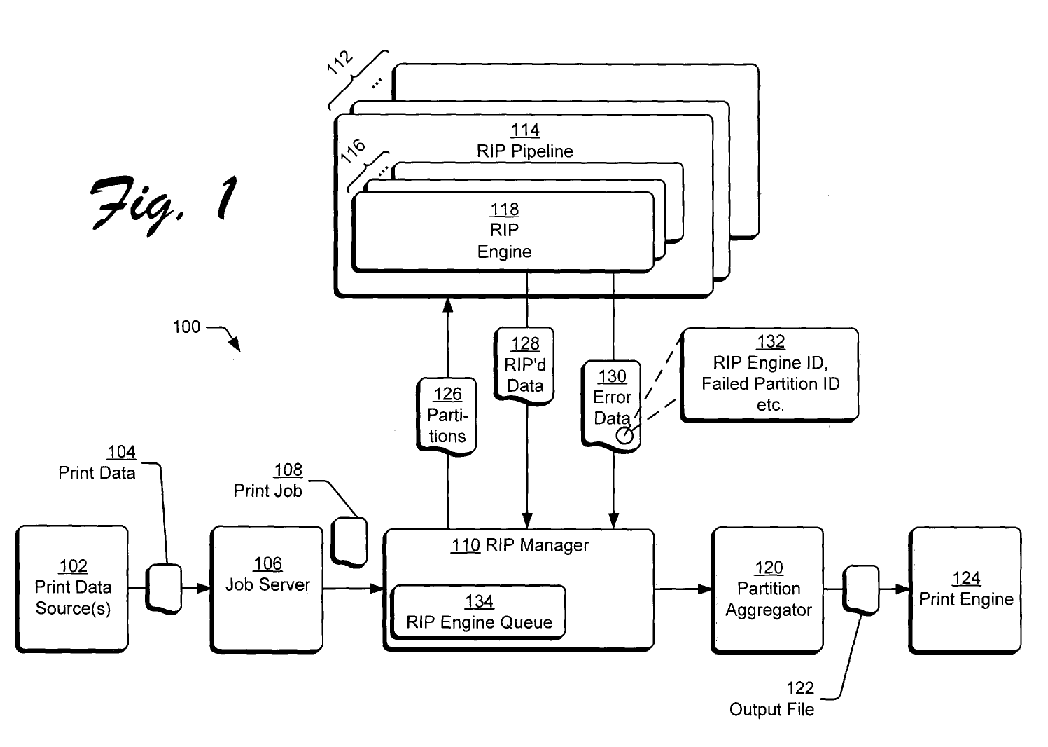

FIG. 1 is an exemplary computing environment 100 suitable for the implementation of systems, apparatuses and methods by which a RIP manager 110 may enhance print shop operation. Exemplary computing environment 100 is only one example of a suitable computing environment and is not intended to suggest any limitation as to the scope of use or functionality of systems and methods the described herein. Neither should computing environment 100 be interpreted as having any dependency or requirement relating to any one or combination of components illustrated in computing environment 100.

As shown in FIG. 1, the exemplary computing environment 100 includes print data source 102, job server 106, RIP manager 110, a plurality 112 of RIP pipelines 1 14, each pipeline having a plurality 1 16 of RIP engines 118, raster imaged processed (“RIPed”) partition aggregator 120, and one or more print engines or device(s) 124, each of which are now described. The job server 106 receives, uploads, or otherwise accesses print data 104 from a print data source 102. Print data 104 may be expressed in page description language (PDL) and may be authored using standard authoring tools. The print data source 102 can be local or remote to the exemplary computing environment 100. A local print data source 102 may consist of any combination of a standalone computing device and/or volatile/non-volatile computer storage media that is coupled to the job server 106. Remote or external data source(s) are coupled to the job server 106 over a network (not shown) such as the Internet.

The job server 106 generates a print job 108 from the print data 104. This is accomplished using any combination of known automated and/or administrator directed techniques for generating print jobs from print data. A print job includes, for example, the print data, an analysis of the complexity of the print data, page size, associated color spaces, etc. The job server 106 provides this information to the RIP manager via the print job 108.

Each of the plurality 112 of RIP pipelines 114 may includes a plurality 116 RIP engines 118 for translating (i.e. raster image processing, typically referred to as “RIPing”) the vector image or high-level page description language (PDL) data expressed in the print job 108 into bitmapped data. The information in a print job 108 is assigned by the RIP manager 110 to one or more partitions 126. Partitions can be a segment or subset of a print job, and can be of a smaller and more manageable size than an un-partitioned print job. Accordingly, partitions can facilitate the division of a print job for possibly simultaneous RIPing by a plurality of RIP engines. For example, the RIP manager 110 may encapsulate print data 104 into multiple partitions 126. The number of partitions into which the print data is divided is a function of print data size, the availability of RIP resources in one or more pipelines 108 to process the print job, and/or other print shop workflow criteria. Thus, a partition may include a wide range of pages of print data (e.g., tens, hundreds, or thousands of pages of print data). Each partition is sent to a RIP pipeline 114 selected from among the plurality of pipelines 112, where a RIP engine 118 selected from among the plurality of RIP engines 116 performs the RIPing.

The RIP manager 110 distributes partitions 126 across the RIP engines 116 in the pipeline 114. Partition distribution may be based on any number of different criteria such as resource availability, partition size, current and/or anticipated print shop workflow, and so on. Responsive to receiving a partition, a RIP engine attempts to RIP the partition. If the partition is successfully RIPed, the RIP engine communicates corresponding RIPed data 128 to the RIP manager. Each partition 126 which is successfully RIPed will have a corresponding set of RIPed data 128.

When the RIP manager 110 receives a block of RIPed data 128, the RIPed data is forwarded to the data partition aggregator 120 for subsequent sorting with respect to other blocks of RIPed data and eventual aggregation into the output file 122 for printing by the print device(s) 124.

During the RIPing process, a RIP engine 118 within a RIP pipeline 114 may fail to successfully RIP a particular partition 126. The RIP engine 118 may fail for any of a number of reasons, such as an integrated circuit failure on the computer on which the RIP engine operates, power outages, network, transmission problems, etc. Responsive to such failures, existing techniques require that the entire print job be reRIPed by other available RIP engines 116 remaining within the pipeline. Since the RIP engines 116 remaining within the RIP pipeline will be unable to RIP the partitions 126 as quickly without the failed RIP engine 118, the failure of one or more RIP engines can substantially disrupt the workflow in a print shop. In contrast to such existing techniques in such a situation, the systems, apparatus, and methods of the exemplary computing system 100 will hot swap (i.e. without turning off the pipeline, so that RIP engines within the pipeline continue to function) an available RIP engine into the RIP pipeline 114 to replace the failed RIP engine. In one embodiment, the available RIP engine swapped into the RIP pipeline 114 will be discovered by reference to a RIP engine queue 134, which maintains a roster of available—or potentially available—RIP engines. For example, the RIP engine queue 134 may include the name of the RIP engine and the IP address of the computer on which it is installed.

During the RIPing process, re-aggregation of the output file 122 containing video data (i.e. “raster data” or “device ready bits”) associated with the print job 108 may fail. The failure may be caused by the failure of the RIPing process to RIP one or more of the partitions 126 into which the print job 108 was divided. Data concerning the failure may be included within error data 130 which is sent from the RIP pipeline 118 to the RIP manager 110. The error data 130 may include specific information 132 on a partition ID of a partition which was not RIPed and a RIP engine to which the partition was sent. The RIPing failure may have been caused by the failure of a RIP engine 118. Responsive to the failure of a partition to RIP, existing techniques require that entire print job 108 be RIPed again. However, this may result in a similar failure. In contrast to such existing techniques in such a situation, the systems, apparatus, and methods of the exemplary computing system 100 will determine the ID of the partition 126 which failed to properly RIP, and re-send that partition 126 to a different RIP engine. The RIP engine to which the partition was originally sent may be taken off-line for diagnostics. Responsive to the failure of a RIP engine, existing techniques require that an entire pipeline be shut down and reconfigured with an additional RIP engine. In contrast to such existing techniques in such a situation, the systems, apparatus, and methods of the exemplary computing system 100 will hot swap (i.e. without turning off the pipeline, so that RIP engines within the pipeline continue to function) an operational RIP engine into the RIP pipeline to replace the failed RIP engine.

Within the environment 100, any of the plurality of pipelines 112 could encounter a schedule wherein higher-than-expected workload is received. This increased workload could result in a failure to RIP partitions in a timely manner. Responsive to such a failure, existing techniques require that additional time be assigned for completion of the higher-than-expected workload. In contrast to such existing techniques in such a situation, the systems, apparatus, and methods of the exemplary computing system 100 will gather statistics on workload activity over time, allowing prediction of most changes in workload activity. Using this statistical information, the RIP pipelines may be configured to more timely complete the workload.

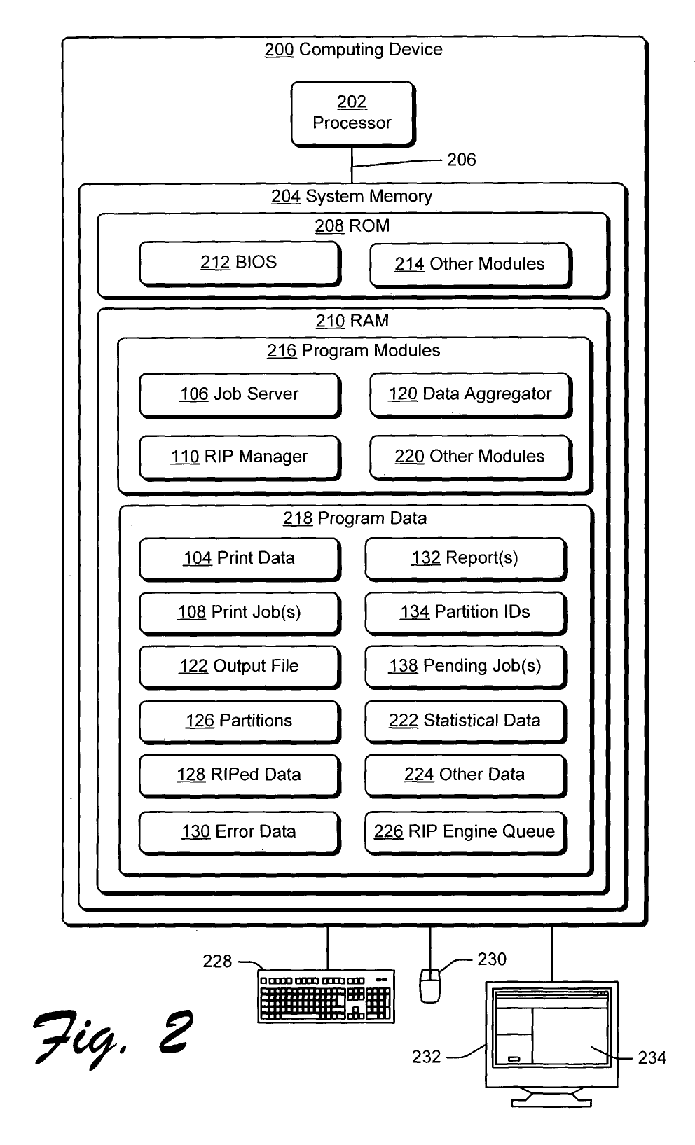

FIG. 2 shows an exemplary computing device 200 configured for resiliency in the face of changing workloads, RIP engine failures and the re-aggregation failures (e.g. the failure of RIPed partitions 126 to recombine into output 122 suitable for driving a print engine 124). Exemplary computing device 200 is only one example of a suitable computing device within which program modules and data to automatically recover a failed RIP partition may be implemented. Thus, computing device 200 is not intended to suggest any limitation as to the scope of use or functionality of systems and methods the described herein. For example, although the program modules 216 and program data 218 are shown in FIG. 2 as being implemented in a single computing device 200, an individual module and/or combinations of the program modules and data could be implemented across multiple computing devices in a distributed processing computing environment.

The components of computing device 200 include one or more processors 202, system memory 204, and bus 206 that couples various system components including the processor to the system memory. Bus 206 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus also known as Mezzanine bus.

Computing device 200 includes a variety of computer readable media. Such media may be any available media that is accessible by computer 200, and it includes both volatile and non-volatile media, removable and non-removable media. In FIG. 2, system memory 204 includes computer-readable media in the form non-volatile memory, such as read-only memory (ROM) 208, and/or volatile memory, such as random access memory (RAM) 210. A basic input/output system (BIOS) 212 contains basic routines that help to transfer information between elements within computer 200, such as during start-up, and is stored in ROM 208 along with other firmware modules 214. Computer 200 may be configured to include other removable/non-removable, volatile/non-volatile computer storage media (not shown) such as a hard disk drive, a CD-ROM, a magnetic tape drive, and/or others.

RAM 210 (or a disk, not shown) may contain program modules 216 and program data 218 that are accessible to and/or presently being operated on by the processor 202. For purposes of discussion, a number of the program modules and data are representative of the program modules and data described above with respect to FIG. 1. To facilitate cross-referencing between FIGS. 1 and 2, the left-most digit of a component's reference number identifies the figure in which the reference number first appears. For instance, program modules 216 includes job server 106, RIP manager 110, data aggregator 120, and other modules 220 such as an operating system (OS) to provide a runtime environment, and so on. Each program module with a reference number that begins with a “1” was described above in reference to FIG. 1 and is also illustrated therein. Along this line, program data 218 includes, for example, uploaded or downloaded print data 104, print job(s) 108, output file 122, partitions 126, RIPed data 128, error data 130, and so on.

Statistical data 222 may be stored in a database or similar data structure, within or accessible to, the RIP manager 110. Statistical data 222 allows the RIP manager 110 to more accurately predict future workload, in part based upon historical workload levels. Such workload levels may be based on workload at specific times of the day, week, month and/or year, and may be associated with the type of work (e.g. PDF, PostScript(g or other work type), and other factors and data. Additional data storage 224 may be used as needed. For example, a RIP engine queue 226 or data structure showing RIP engine names and IP addresses may be included.

A user may provide commands and information into computer 200 through input devices such as keyboard 228 and pointing device 230 (such as a “mouse”). Other input devices (not shown) may include an Internet connection, a LAN connection, a microphone, joystick, game pad, satellite dish, serial port, scanner, camera, etc. These and other input devices are connected to the processing unit 202 through a user input interface (not shown) that is coupled to bus 206, but may be connected by other interface and bus structures, such as a parallel port, game port, a universal serial bus (USB), or an IEEE 1394 (Firewire) bus.

A monitor 232 or other type of display device is also connected to bus 206 via an interface, such as a video adapter (not shown). A user interface (UI) 234 is presented via the monitor or presented via voice activated interfaces, and/or the like. The UI 234 allows an administrator to view current and pending print jobs, statistics associated with RIP pipeline workload, RIP engine movement between pipelines, and so on.

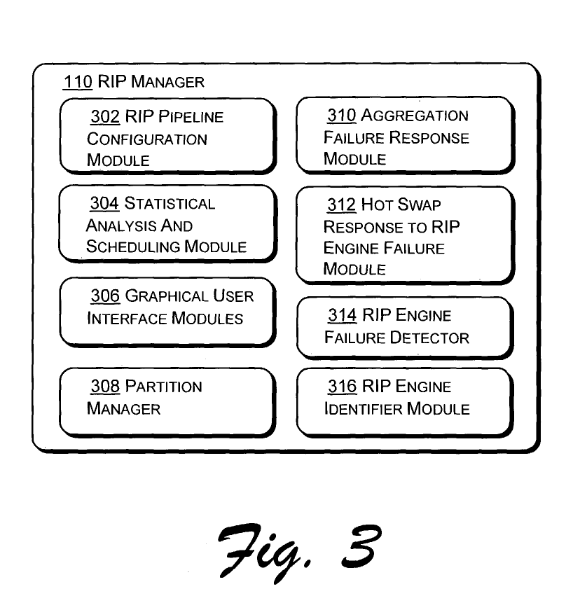

FIG. 3 shows additional detail of the RIP manager 110, and is not intended to suggest any limitation as to the scope of use or functionality of systems and methods the described herein. Exemplary RIP manager 110 is configured to oversee the RIPing of partitions 126 associated with print jobs 108, and the management of one or more RIP pipeline 114, each having one or more RIP engine 118. Following RIPing, the RIP manager 110 oversees the delivery of the RIPed partitions 128 to the partition re-aggregator 120 for formation of an output file 120 for transmission to a print engine 124. The RIP manager may include one or more software, firmware or other logically operated modules, such as a pipeline configuration module 302, a statistical analysis and scheduling module 304, a graphical user interface support module 306, a partition manager 308, an aggregation failure response module 310, a hot swap response to RIP engine failure module 312, a RIP engine failure detector module 314 and a RIP engine identifier module 316. Other or different modules could be includes in similar implementations, as desired.

A RIP pipeline configuration module 302 is configured to automatically or manually configure one or more RIP pipelines 114 (FIG. 1), wherein each RIP pipeline 114 is configured with one or more RIP engines 118 (FIG. 1). Each RIP pipeline may be configured for operation on partitions 126 (FIG. 1) of a particular type, such as PostScript(#. The RIP pipeline configuration module 302 may act under the direction of an administrator or other user giving directions through the user interface 234 (FIG. 2). Alternatively, the RIP pipeline configuration module 302 may act in an automated fashion under the direction of the statistical analysis and scheduling module 304.

The statistical analysis and scheduling module 304 observes workflow and records information on the workload assigned to different RIP pipeline types (e.g. a RIP pipeline configured to RIP PostScript® or PDF® partitions) in a data base 222 or similar location. Such information can include workload level, workload type (e.g. PostScript® or PDF® partitions), time (including hour of day, day of week, date within the month, etc.). The information can also include number of jobs that are kept waiting, how long they waited and when they waited. Where the workload on any given type of RIP pipeline is expected to be somewhat cyclical (e.g. similar types of work and workloads at similar times of the day, week, month, quarter or year) the statistical analyzer 304 may be configured to predict a level and type of workload expected at different times in the future. The RIP pipeline configuration module 302 may then be directed to configure RIP pipelines to handle the level and type of workload expected.

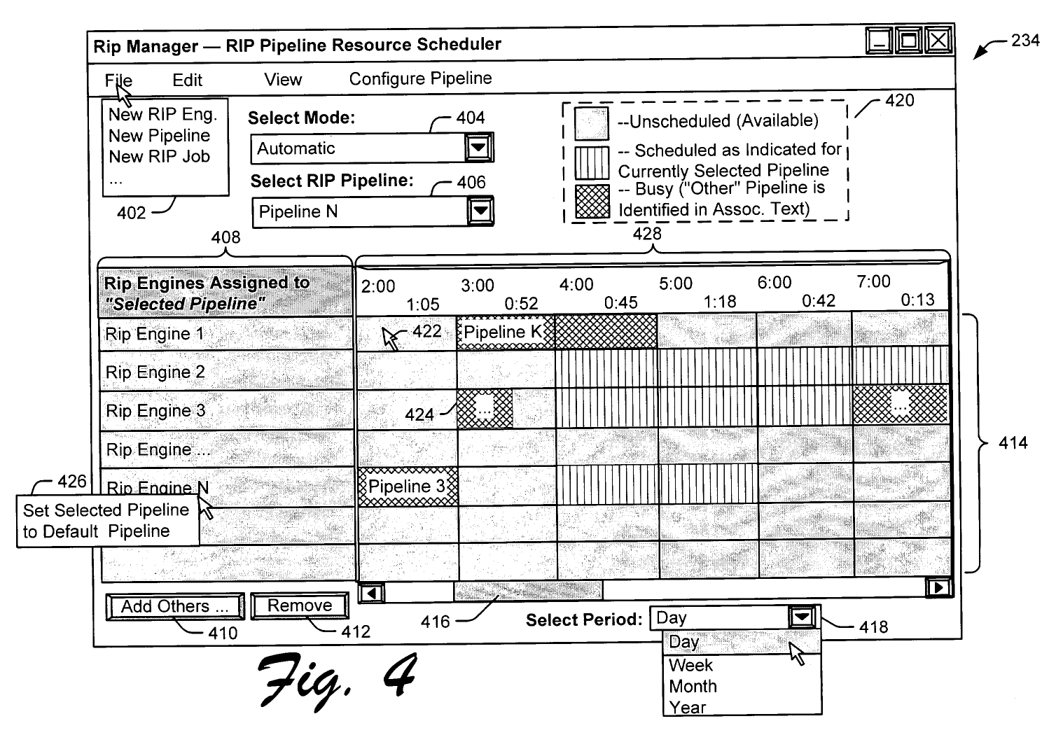

Graphical user interface module 306 includes the software or other logic to support the graphical user interface 234. For example, to support the graphical user interface 234 (seen in greater detail in FIG. 4), processor executable statements implemented in software or firmware could be used. The graphical user interface module 306 may be configured to communicate with the RIP pipeline configuration module 302, thereby allowing the administrator or other user to direct configuration of a RIP pipeline 114.

A partition manager 308 is configured to segment the print job 108 into partitions 126 and to manage the resulting RIPed data 128 returned by the RIP pipelines 114. The partition manager 308 may additionally be configured to oversee the identification, storage, and transmission of the partitions 126 and RIPed data 128.

The partition manager 308 may additionally be configured to receive and process the error data 130, thereby enabling the partition manager 308 to keep track of partitions which were unsuccessfully RIPed. The failure of a partition 126 to be returned from the RIP pipeline 118 to which it was sent in a timely manner can prevent re-aggregation of the RIPed data 128. Accordingly, the partition manager 308 may easily be configured to report an aggregation failure to the aggregation failure response module 310, along with data concerning the partition 126 which failed during the RIPing process.

The aggregation failure response module 310 may be separately configured, or may be configured within the partition manager 308. The aggregation failure response module 310 may be configured to receive or discover information indicating a failure of a print job to re-aggregate and/or the failure of a partition 126 to be RIPed. Upon such indication, the aggregation failure response re-sends the partition 126 which failed to be properly RIPed by a first RIP engine to a second RIP engine. The first and second RIP engines may be within the same or different RIP pipelines. Upon successful RIPing of the partition 126, the partition manager 308 delivers the partition to the partition aggregator 120 to be aggregated with the other partitions 126 thereby forming the output file 122.

A hot swap response to RIP engine failure module 312 is configured to replace a failed RIP engine with a functional RIP engine. In one embodiment, the failed RIP engine is removed from the RIP pipeline 114 in which it is configured. The functional RIP engine is typically allowed to finish RIPing a partition (if any) on which it is currently performing RIP. The functional RIP engine is then reconfigured within the RIP pipeline within which the failed RIP engine was originally configured. During this process, other RIP engines within one or both RIP pipelines are allowed to continue RIPing partitions.

The hot swap response to RIP engine failure module 312 may communicate with a RIP engine identifier module 316 which may maintain a RIP engine queue 226, which includes locations of RIP engines which could be swapped for failed RIP engines on short notice.

FIG. 4 shows details of the exemplary user interface 234 of FIG. 2 for enhancing management of RIP resources. Exemplary UI 234 is configured to allow the RIP manager 110 (FIG. 1) to convey to an administrator or other user the statistics gathered by the statistical analysis and scheduling module 304. UI 234 allows a user to configure pipelines 114 (FIG. 1), and in particular to schedule RIP engines for inclusion within a given pipeline, and for movement between two or more pipelines. A number of UI control components such as text, labels, dropdown menus, scroll bars and lists, and so on, are described below with respect to UI 234. Although specific titles, text, control positioning, and overall layout of UI 234 are described, the UI 234 of FIG. 4 is only one possible implementation of the user interface 234. Thus, different titles, labels, UI controls, layout, and so on can be used to implement the following described features of UI 234. For purposes of discussion, the components of UI 234 (i.e., UI controls) are described in reference to various components of FIGS. 1 and 2.

In this exemplary implementation, UI 234 includes multiple UI controls. Such controls include, for example: file menu 402, select mode menu 404, select pipeline menu 406, “RIP Engines Assigned to the ‘Selected Pipeline’” list box 408, button controls 410 and 412, RIP engine scheduling control area 414, scrollbar control 416, select period menu 418, legend 420, cursor 422, individual RIP engine scheduling time slot locations 424, context sensitive popup menu 426 and display region 428 within which projected waiting periods associated with the RIPing of partitions in different time periods is displayed. Each of these UI components and their functionality are now described.

A RIP pipeline schedule 414 is produced by the RIP pipeline configuration module 302, and reflects input from the statistical analysis and scheduling module 304 and/or the user interface 234. The RIP pipeline schedule 414 maps out the arrival and processing times of known incoming work (e.g. partitions to be RIPed), illustrates the number and type of RIP pipelines 114 (e.g. pipelines for RIPing PostScript(E or PDF(®) at any given time, and also maps out the reconfiguration of those RIP pipelines 114 as RIP engines 118 are moved between such pipelines.

File menu 402 is used to create/add new RIP entities, such as new RIP pipelines, new RIP engines and new RIP jobs. When an administrator creates a RIP pipeline, engine or job, a substantially unique name may be created for future reference.

Select mode menu 404, which in this implementation is a drop-down menu, allows a user to select a particular mode from among a number of modes, such as automatic and manual. Although only one mode is shown in this example (“automatic”), the interactive arrow control feature at the right of the dropdown menu 404 allows for the display and selection of individual modes of multiple choices. “Automatic” mode allows the statistical analysis and scheduling module 304 (FIG. 3) to instruct the RIP pipeline configuration module 302 (FIG. 3) to move available RIP engines 118 (FIG. 1) between RIP pipelines 114 (FIG. 1) as needed, to optimize overall performance. When the dropdown menu 404 is used to select “Manual” mode the user is allowed to regulate similar functionality in a manual manner, typically through a graphical user interface, such as UI 234.

A similar Select RIP Pipeline 406 drop down menu allows selection of a RIP pipeline from among those pipelines currently available, having been previously created by operation of the file menu 402.

Responsive to selecting RIP pipeline via dropdown menu 406, “Select RIP Pipeline” dropdown menu is populated with the specific names of zero (0) or more pipelines 114 (FIG. 1) for display and user selection. The number of pipelines that are actually presented in the “Select RIP Pipeline” menu is in part a function of the number of pipelines that have been previously created. In this example, list box shows that RIP Engines 1, 2, 3 . . . , and N have already been added to “Pipeline N”. Although FIG. 4 shows only one pipeline (“Pipeline N”), the arrow control feature at the right of the dropdown menu 406 allows for the display and selection of individual pipelines by name or other identification from among those available.

In this exemplary implementation, there are numerous ways to create, modify or delete elements within the RIP pipeline schedule 414. For example, such operations can be performed via the edit menu, button controls such as the “Add Others . . . ” 410 and “Remove” 412 button controls, keyboard controls 228 (FIG. 2), context sensitive popup menus (not shown) displayed over a corresponding schedule or pipeline, etc.

Responsive to selection of a pipeline from the “Select RIP Pipeline” dropdown menu 406, “RIP Engine . . . ” list control 408 is populated with the specific names of the RIP engines 118 (FIG. 1) that are associated with the pipeline 114. In this example, list box shows that RIP Engines 1, 2, 3, . . . , and N have already been added to “Pipeline N”. In this implementation, the “Add Others . . . ” button control 410 allows a user to add another RIP engine, if available, to the selected pipeline. The “Remove” button control 412 allows for removal of a selected RIP engine from the list control 408, and thereby from the specified pipeline.

Responsive to selection of a pipeline from the “Select RIP Pipeline” dropdown menu 406, RIP engine scheduling control 414 is populated with the specific schedules that apply to each of the RIP engines 114 (FIG. 1) identified in the “RIP Engine . . . ” list 408. A RIP engine's corresponding pipeline assignment schedule is specified directly across (i.e., in the same row) from the listed RIP engine. In this exemplary implementation, the RIP engine scheduling control 414 shows RIP engine schedules with respect to a daily view. The particular time increments selected for use in the daily view is a user configurable parameter. For example, selection of the view dropdown menu 418 allows a user to change the way that the information in the RIP engine scheduling control 314 is displayed. Rather than displaying RIP engine 114 (FIG. 1) processing schedules with respect to a daily as shown in FIG. 4, weekly, monthly, yearly, and/or other types of views can be used to view the schedules. Thus, the daily schedule of RIP engine pipeline assignments could also be presented, for example, with respect to fifteen (15) minute increments, one-half hour time increments, and so on.

Scroll bar control 416 allows the user to scroll the contents of the scheduling control area 414. For instance, in this example, to view RIP Engine schedule that are earlier than 2:00 am (the times are shown in military time), the user will move the thumb control in the scroll bar to the left. To view RIP Engine schedule that are later than 7:00 am, the user will move the thumb control in the scroll bar to the right.

Legend 420 contains explanatory information for a user to interpret information displayed in the RIP engine scheduling control area 414. In this exemplary implementation, unscheduled time is represented with a first pattern/color. For purposes of illustration, a pattern may be the absence or presence of pattern, and a color may be the absence or presence of color. Scheduled time is shown in a second color/pattern when a RIP engine 118 (FIG. 1) is scheduled for processing in the selected pipeline 114 (FIG. 1). Busy time is shown in a third color/pattern when a RIP engine is scheduled for processing in a pipeline other than the selected pipeline. When scheduled time belongs to a pipeline other than the selected pipeline, the name of the other pipeline is displayed within the scheduled time slot or represented with ellipses when there is not enough display area. A popup text box could display the entire name if the user hovers the mouse cursor over the truncated name on the screen.

In this implementation an unscheduled time slot, for example, the one (1) hour 2:00 time slot for “RIP Engine 1” can be assigned to selected pipeline in multiple different ways. For example, positioning a cursor (e.g., cursor 422) over an unscheduled time slot and double-clicking automatically assigns the time slot to the selected pipeline, which in this example is “pipeline N”. Other ways to assign/modify portions of one, two, or multiple time slots include selecting and dragging the edge of a scheduled time slot horizontally to the left or to the right to indicate the time-period or schedule desired. In this example, a scheduled time slot can be modified with respect to either the selected pipeline or to a different pipeline. Such an edge is represented by edge 424 of the 3:00 to 3:30 time slot that “RIP Engine 8” is scheduled for processing in a pipeline other than the selected pipeline. Other methods include, for example, display of a dialog box (not shown) allowing the user to select start and stop times. Such a dialog box can be displayed in multiple different ways, for example, responsive to context sensitive popup menu item selection over one or more desired time slots, and so on.

Context sensitive popup menu 426 is positioned over a RIP engine identifier within list box 408. Such a context menu allows a user to indicate that the selected pipeline 114 (FIG. 1) will be the default pipeline for the corresponding RIP engine 118 (FIG. 1). In this example, the selected pipeline is “Pipeline N” and the corresponding RIP engine is “RIP Engine N”. This feature allows the user, having selected the manual mode at select mode control 404 to schedule the RIP engine for automatic transfer by the RIP pipeline configuration module 302 (FIG. 3) of the RIP manager 110 (FIG. 1) to the default pipeline when the RIP engine has been idle in another pipeline for a threshold amount of time, or when the RIP engine has completed processing in a particular pipeline other than the default pipeline and is not immediately scheduled for transfer to another pipeline that is not the default pipeline.

Responsive to user selection of the “Set Selected Pipeline to Default Pipeline” menu item 426, all unscheduled time slots for the corresponding RIP engine 114 (FIG. 1) are assigned to the selected pipeline. In this implementation, if the corresponding RIP engine is subsequently scheduled to another pipeline during a time slot that overlaps the time slot(s) assigned to the RIP engine as “default times”, the default times will be overridden. It can be appreciated that other behaviors could be implemented responsive to such an action. For example, depending on the specific interface desired, RIP pipeline configuration module 302 (FIG. 3) could also display a popup window or dialog box notifying the user of the time slot conflict and requesting confirmation, etc.

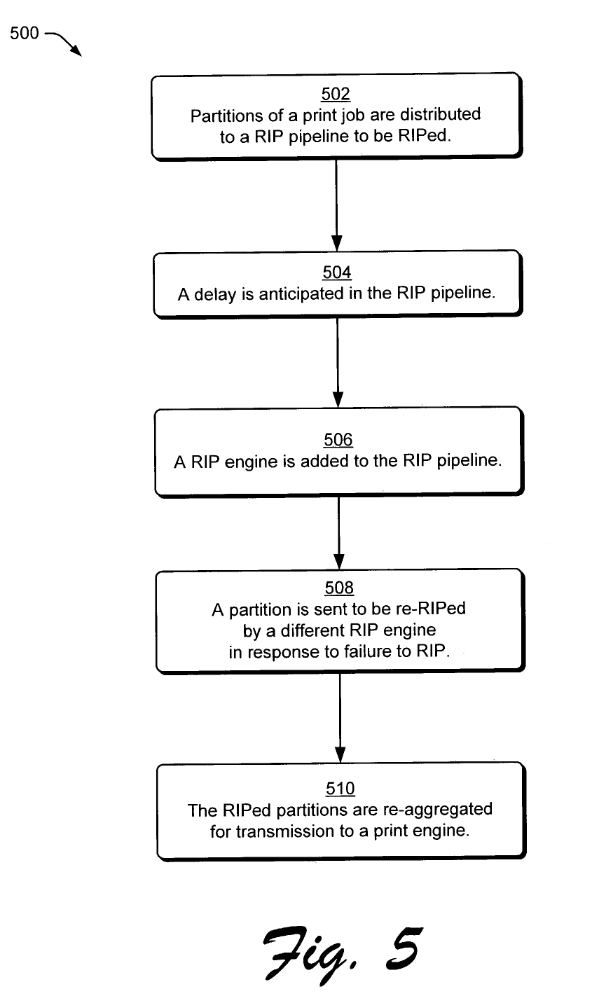

The flow chart of FIG. 5 illustrates a further exemplary implementation, wherein a method 500 is employed to manage RIP resources. The elements of the method may be performed by any desired means, such as by the execution of processor-readable instructions defined on a processor-readable media, such as a disk, a ROM or other memory device or by operation of an application specific integrated circuit (ASIC) or other hardware device. In one embodiment, the ROM may contain firmware implementing one or more of the program modules and/or program data of FIGS. 2 and 3. In an alternative embodiment, an ASIC may contain logic which implements one or more modules of FIGS. 2 and 3 according to an exemplary method as seen in the flow chart of FIG. 5.

At block 502, partitions 126 of a print job 108 are distributed to a RIP pipeline 114 for raster image processing (RIP). Where a plurality of RIP pipelines 112 are configured appropriately (e.g. where the partitions 126 are PostScript(g and where two pipelines are configured for operation on such partitions) partitions may be sent to more than one RIP pipeline 114.

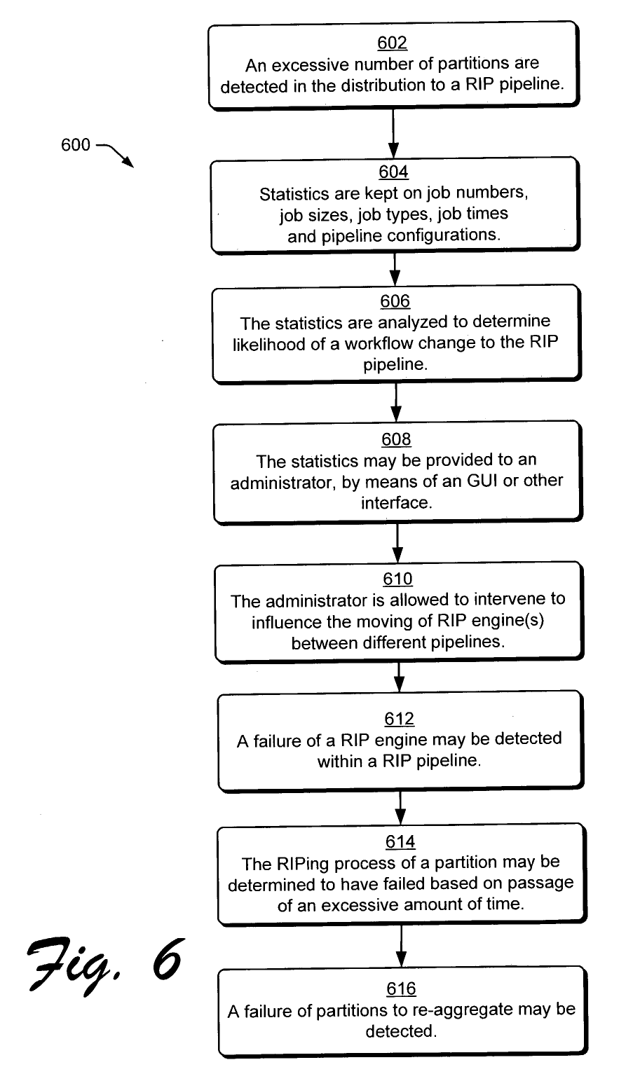

At block 504, a delay may be anticipated in the RIP pipeline(s) 114. As seen in the analysis of FIG. 6, the delay may be the result of any of a number of conditions or reasons, and may be detected in a variety of ways.

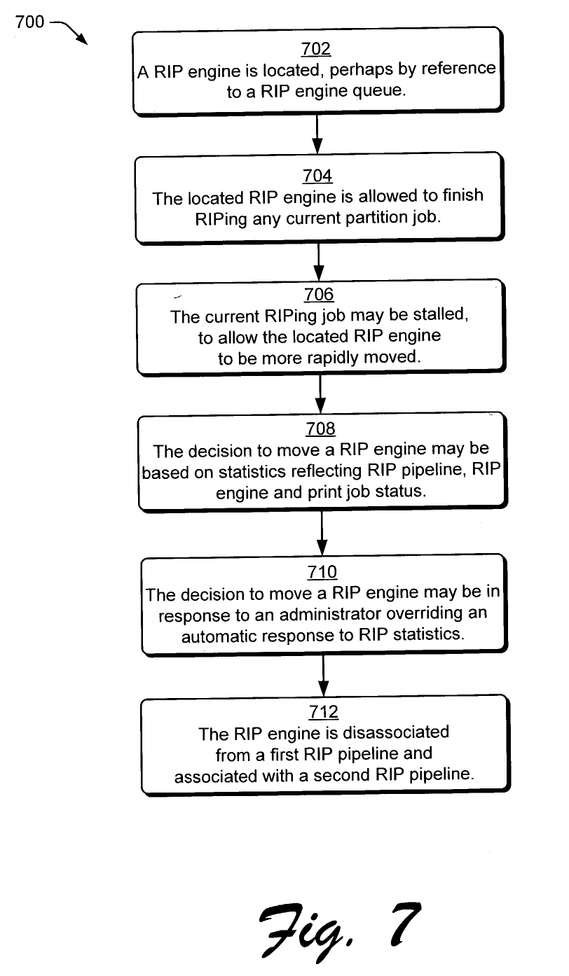

At block 506, a RIP engine 118 may be added to the pipeline 114. The discussion of FIG. 7 explains possible circumstances surrounding this addition with greater detail.

At block 508, a partition 126 is sent to be re-RIPed by a different RIP engine 114 in response to a failure of the partition 126 to RIP. The partition 126 may have failed to RIP because of failure of a first RIP engine. In response, the partition is sent to a second RIP engine.

At block 510, the RIPed partitions 128 are re-aggregated by a partition aggregator 120 to form an output file 122 for transmission to a print engine 124.

The flow chart of FIG. 6 illustrates a further exemplary implementation, wherein a method 600 is employed to anticipate, detect and/or respond to delays in the RIP pipeline. The elements of the method may be performed by any desired means, such as by the execution of processor-readable instructions defined on a processor-readable media, such as a disk, a ROM or other memory device or by operation of an application specific integrated circuit (ASIC) or other hardware device. In one embodiment, the ROM may contain firmware implementing one or more modules, such as the statistical analysis and scheduling module 304 of FIG. 3. In an alternative embodiment, an ASIC may contain logic which implements one or more modules described in FIGS. 2 and/or 3.

At block 602, an excessive number of partitions may be detected in the distribution of a RIP pipeline. Where an excessive number of partitions are detected, a delay in the RIPing process may be anticipated. Similarly, if an excessive number of print jobs are available, a delay may also be anticipated.

At block 604, statistics are kept on the number of jobs, job sizes, job types, job times and pipeline configurations. At block 606, the statistics are analyzed to determine the likelihood of a workflow change to the RIP pipeline. For example, the last several days of previous months may have been very busy; accordingly, the last several days of a current or upcoming month may be anticipated to be very busy.

At block 608, the statistics may be provided to an administrator, or other user, by an interface such as graphical user interface 234 of FIG. 4. The statistics may allow the administrator to spot partitions 126 associated with a particularly important print job 108 within a pipeline 114. At block 610, where the administrator desires to alter the schedule of one or more print job 108, the operator may intervene to influence movement of the important print job through the RIPing process by the moving of RIP engine(s) between different pipelines, thereby adding processing power needed to move the important print job through the RIPing process.

At block 612, a failure may be detected in the RIPing process. Similarly, at block 614 the RIPing process of a partition may be determined to have failed based on passage of an excessive amount of time. And further, at block 616, a failure of partitions to re-aggregate may be detected. Such a failure to re-aggregate would indicate either an unacceptable delay or a failure in the RIPing process of a print job 108.

The flow chart of FIG. 7 illustrates a further exemplary implementation, wherein a method 700 is employed to add or replace RIP engines 118 within a pipeline 114, and to move RIP engines between pipelines 112. The elements of the method may be performed by any desired means, such as by the execution of processor-readable instructions defined on a processor-readable media, such as a disk, a ROM or other memory device or by operation of an application specific integrated circuit (ASIC) or other hardware device. In one embodiment, the ROM may contain firmware implementing the hot swap response to RIP engine failure module 314 of FIG. 3, or other modules in FIGS. 2 and/or 3. In an alternative embodiment, an ASIC may contain logic which implements hot swap response to RIP engine failure module 312, or other module.

At block 702, a RIP engine is located, perhaps by reference to a RIP engine queue 134 or similar data structure. The RIP engine may be referenced by a name or an IP address, as desired.

At block 704, where desired, the RIP engine is allowed to finish any unfinished RIP job. Alternatively, at block 706, the current RIPing job may be stalled or temporarily suspended, to allow the located RIP engine to be more rapidly moved.

At block 708, a decision to move a RIP engine may be made in response to statistics reflecting RIP pipeline, RIP engine and print job status. Similarly, at block 710, the decision to move the RIP engine may be made in response to an administrator overriding an automatic response to RIP statistics.

At block 712, the RIP engine is disassociated from a first RIP pipeline (if the RIP engine was associated with a RIP pipeline) and is associated with a second RIP pipeline.

Although the disclosure has been described in language specific to structural features and/or methodological steps, it is to be understood that the appended claims are not limited to the specific features or steps described. Rather, the specific features and steps are exemplary forms of implementing this disclosure. For example, while, actions described in blocks of the flow diagrams may be performed in parallel with actions described in other blocks, the actions may occur in an alternate order, or may be distributed in a manner which associates actions with more than one other block.

Additionally, while one or more methods have been disclosed by means of flow charts and text associated with the blocks, it is to be understood that the blocks do not necessarily have to be performed in the order in which they were presented, and that an alternative order may result in similar advantages.

1. A processor-readable medium comprising processor executable instructions for management of raster image processing (RIP) resources, the processor executable instructions comprising instructions for:
distributing partitions of a print job to a RIP pipeline to be RIPed;
anticipating a delay in the RIP pipeline; and
adding a RIP engine to the RIP pipeline in response to the delay.

2. A processor-readable medium as recited in claim 1, wherein the anticipating comprises further instructions for:
analyzing statistics to determine likelihood of a work-flow change to the RIP pipeline.

3. A processor-readable medium as recited in claim 1, wherein the anticipating comprises further instructions for:
detecting an excessive number of partitions to be distributed to the RIP pipeline.

4. A processor-readable medium as recited in claim 1, wherein the anticipating comprises further instructions for:
detecting a failure of a RIP engine within the RIP pipeline.

5. A processor-readable medium as recited in claim 1, wherein the anticipating comprises further instructions for:
detecting a failure by partitions RIPed by the RIP pipeline to re-aggregate.

6. A processor-readable medium as recited in claim 1, wherein the adding comprises further instructions for:
allowing the RIP engine to completely process a pending partition within a different RIP pipeline; and
disassociating the RIP engine with the different RIP pipeline and associating the RIP engine with the RIP pipeline.

7. A processor-readable medium as recited in claim 1, wherein the adding comprises further instructions for:
looking for an additional RIP engine; and
configuring the additional RIP engine within the RIP pipeline.

8. A processor-readable medium as recited in claim 1, comprising further instructions for:
detecting that a RIPing process associated with a partition has timed out; and
re-sending the partition to be RIPed by a different RIP engine within the RIP pipeline.

9. A processor-readable medium as recited in claim 1, comprising further instructions for:
keeping statistics on job numbers, job sizes, job types and job times;
moving a RIP engine between the RIP pipeline and a second RIP pipeline in response to the statistics.

10. A processor-readable medium as recited in claim 9, comprising further instructions for:
providing the statistics to an operator; and
allowing the operator to intervene in the moving of the RIP engine between the RIP pipeline and the second RIP pipeline.

11. A processor-readable medium as recited in claim 1, comprising further instructions for:
stalling a first print job; and
moving a RIP engine from a second RIP pipeline wherein the first print job is stalled into the RIP pipeline.

12. A processor-readable medium as recited in claim 1, comprising further instructions for:
re-aggregating RIPed partitions for transmission to a print engine.

13. A processor-readable medium as recited in claim 12, comprising further instructions for:
evaluating a checksum and/or file size check to determine if the RIPed partitions have been re-aggregated.

14. A computing device for enhancing management of raster image processing (RIP) resources, the computing device comprising:
a processor;
a memory coupled to the processor, the memory comprising computer-program instructions executable by the processor for:
anticipating a delay in a first RIP pipeline;
re-configuring the first RIP pipeline by moving a RIP engine from a second RIP pipeline to the first RIP pipeline; and
distributing partitions of a print job to the first RIP pipeline to be RIPed.

15. The computing device of claim 14, wherein the computer instructions are additionally executable by the processor for:
analyzing statistics to determine likelihood of a work-flow change; and
automatically moving the RIP engine in response to the statistics.

16. The computing device of claim 15, wherein the computer instructions are additionally executable by the processor for:
allowing a user to override the automatic moving by operating a user interface.

17. The computing device of claim 14, wherein the computer instructions are additionally executable by the processor for:
allowing the RIP engine to complete processing on a current partition; and
automatically moving the RIP engine as indicated by statistics.

18. A method for management of raster image processing (RIP) resources, the method comprising:
detecting failure of a first RIP engine within a RIP pipeline to RIP a partition;
adding a second RIP engine to the RIP pipeline; and
sending the partition to the second RIP engine within the RIP pipeline.

19. The method as recited in claim 18, wherein adding the second RIP engine additionally comprises:
looking for an additional RIP engine; and
allowing the additional RIP engine to completely process any pending partition; and
disassociating the additional RIP engine from a former RIP pipeline and associating the additional RIP engine with the RIP pipeline.

20. The method as recited in claim 19, wherein looking additionally comprises:
stalling a first print job associated with the additional RIP engine; and
moving the additional RIP engine from a second RIP pipeline, wherein the first print job is stalled, to the RIP pipeline.

21. The method as recited in claim 18, wherein detecting failure comprises:
detecting that a RIPing process associated with the partition has timed out.

22. The method as recited in claim 18, additionally comprising:
keeping statistics and
moving the second RIP engine to the RIP pipeline in response to the statistics.

23. The method as recited in claim 22, additionally comprising:
providing the statistics to an operator through a user interface; and
allowing the operator to intervene, by operation of the user interface, in movement of RIP engines.

24. A raster image process (RIP) manager, comprising:
a statistical analyzer to determine statistics on periods of time during which increased numbers of partitions will be sent for RIPing;
a pipeline configurator to move RIP engines between RIP pipelines in response to the periods of time during which increased numbers of partitions will be sent for RIPing; and
a user interface to present an administrator with the statistics.

25. The raster image process (RIP) manager of claim 24, additionally comprising:
a hot swap unit to move a RIP engine from a first pipeline to a second pipeline while at least one of the first pipeline and the second pipeline is involved in RIPing.

26. The raster image process (RIP) manager of claim 24, additionally comprising:
a partition manager to segment a print job into a plurality of partitions and to send the partitions to be RIPed; and
a partition re-aggregator to receive RIPed partitions for re-aggregation and transmission to a print engine and to discover partitions which have failed to be RIPed; and
wherein the partition manager is additionally configured to send the partitions which have failed to be RIPed to a different RIP engine.

27. A raster image process (RIP) manager, comprising:
means for partitioning a print job for distribution to RIP engines within a RIP pipeline;
means for anticipating a delay in the RIP pipeline; and
means for configuring the RIP pipeline with an additional RIP engine.

28. The raster image process (RIP) manager as recited in claim 27, wherein the means for anticipating a delay comprises further means selected from among a group comprising:
means for learning of a failure by partitions RIPed by the RIP pipeline to re-aggregate;
means for determining if a number of partitions to be distributed to the RIP pipeline is excessive;
means for reviewing statistics to predict a work-flow change to the RIP pipeline; and
means for detecting a RIP engine failure.

29. The raster image process (RIP) manager as recited in claim 27, wherein the means for configuring the RIP pipeline comprises:
means for allowing the additional RIP engine to finish processing a pending partition within a different RIP pipeline; and
means for disassociating the additional RIP engine with the different RIP pipeline and associating the additional RIP engine with the RIP pipeline.

30. The raster image process (RIP) manager as recited in claim 27, wherein the means for configuring the RIP pipeline comprises:
means for looking for the additional RIP engine; and
means for moving the additional RIP engine into the RIP pipeline.

31. The raster image process (RIP) manager as recited in claim 27, additionally comprising:
means for detecting that a RIPing process associated with a partition has timed out; and
means for re-sending the partition to be RIPed by a different RIP engine within the RIP pipeline.

32. The raster image process (RIP) manager as recited in claim 31, additionally comprising:
means for keeping statistics on job numbers, job sizes, job types and job times; and
means for moving RIP engines between the RIP pipeline and a second RIP pipeline in response to the statistics.

33. The raster image process (RIP) manager as recited in claim 32, additionally comprising:
means for providing the statistics to an operator; and
means for allowing the operator to control operation of the means for moving RIP engines.

34. The raster image process (RIP) manager as recited in claim 27, additionally comprising:
means for stalling a second print job in a second RIP pipeline; and
means for moving RIP engines from the second RIP pipeline to the RIP pipeline.

35. The raster image process (RIP) manager as recited in claim 27, additionally comprising:
means for evaluating a checksum and/or file size check to determine if RIPed partitions are available to be re-aggregated.

36. The raster image process (RIP) manager as recited in claim 27 additionally comprising:
means for re-aggregating RIPed partitions for transmission to a print engine.
